(19) United States
(12) Patent Application Publication
(10) Pub. No.: US 2014/0180450 A1
(43) Pub. Date: Jun. 26, 2014

(54) VIDEO AND AUDIO EVALUATION METHOD AND SYSTEM

(71) Applicant: Thomas R. DeMorro, JR., Killingworth, CT (US)

(72) Inventor: Thomas R. DeMorro, JR., Killingworth, CT (US)

(21) Appl. No.: 14/133,777

(22) Filed: Dec. 19, 2013

Related U.S. Application Data
(60) Provisional application No. 61/740,095, filed on Dec. 20, 2012.

(51) Int. Cl. G06Q 10/04

(52) U.S. Cl. CPC G06Q 10/04
USPC 700/91

(57) ABSTRACT

A method of scouting players in a sporting event, the method comprising: configuring a computer to operate as a scouting information management engine; receiving, by the scouting information management engine, scouting data; creating a multimedia scouting report using the scouting data received by the scouting information management engine; configuring an output device to provide the multimedia scouting report to a user. A player scouting system comprising: a scouting information management engine configured to: receive scouting data; create a multimedia scouting report using the scouting data; configure an output device to provide the multimedia scouting report to a user.

### CROSS-REFERENCES

This patent application claims the benefit of provisional patent application No. 61/740,095 by Thomas R. DeMorro, Jr., entitled “VIDEO SCOUT—REVOLUTIONARY EVALUATION SYSTEMS”, filed on Dec. 20, 2012, and which provisional application is fully incorporated by reference herein.

### TECHNICAL FIELD

A video and audio evaluation system, and more specifically a video and audio evaluation system that allows for one or more evaluators to provide video synchronized audio commentary with respect to one or more prospects.

### BACKGROUND

Coaches, scouts, agents, and other evaluators routinely make decisions about current or prospective players, athletes, and other performers based, at least in part, on a player's or athlete's athletic ability and performance. Athletic ability is often determined based upon the player's performance in a number of categories relevant to the player's activity. For example, the athletic ability of a baseball pitcher may be determined based on the speed, accuracy, and amount of variety of his pitches, and the athletic ability of a football running back may be determined based upon his speed, agility and strength.

A plurality of athletic parameters is known to help determine athletic ability. For example, a timed run, such as a 60 yard dash is a known athletic parameter for measuring the speed of a player, and the distance a baseball travels after being hit with a bat is another known athletic parameter useful in assessing a batter's athletic ability. The speed of a pitch and the spin on the ball are additional examples of known measurable athletic parameters.

Coaches, scouts, agents, and other evaluators typically measure a plurality of athletic parameters to help determine an athlete's strengths and weaknesses. Scouts and agents may measure athletic parameters to predict how well an athlete would perform on another team or at a higher level. A scout or coach may travel to a college baseball game or training camp to determine whether or not an athlete would be capable of playing with a professional baseball team. Scouts and coaches are often comparing one athlete to another athlete to predict which athlete has more athletic ability in a particular activity. A variety of athletic parameters are separately measured and the scout or coach makes a subjective determination about the athletic ability of the athlete.

Scouting evaluations are written by hand. Coaches and scouts often try to recall thoughts and use notes scribbled down to write game summaries or reports after a game or other sporting exhibitions and events. Traditional scouting may be done by a scout giving an opinion followed by arguments by others behind closed door as to the value of a particular athlete or performer. However, the scout, coach, agent or other individual may forget details about the player's or athlete's performance. Scouts, coaches, and agents may be influenced by other's scouting reports and unconsciously change their evaluations.

Thus there is a need for an improvement for a scouting that overcomes the above listed and other disadvantages.

### SUMMARY OF THE INVENTION

The disclosed invention relates to a method of scouting players in a sporting event, the method comprising: configuring a computer to operate as a scouting information management engine; receiving, by the scouting information management engine, scouting data; creating a multimedia scouting report using the scouting data received by the scouting information management engine; configuring an output device to provide the multimedia scouting report to a user.

The invention also relates to a player scouting system comprising: a scouting information management engine configured to: receive scouting data; create a multimedia scouting report using the scouting data; configure an output device to provide the multimedia scouting report to a user.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a schematic diagram of the disclosed system;

FIG. 2 is a flowchart showing a method of post-production;

FIG. 3 is a block diagram showing the front and back end of the disclosed website;

FIG. 4 is a continuation of the block diagram from FIG. 3;

FIG. 5 is a continuation of the block diagram from FIGS. 3 and 4;

FIG. 6 is a screen shot from the disclosed website;

FIG. 7 is a screen shot from the disclosed website;

FIG. 8 is a screen shot from the disclosed website;

FIG. 9 side perspective view of the disclosed two camera stand;

FIG. 10 is a rear perspective view of the disclosed two camera stand; and

FIG. 11 is another screen shot from the disclosed website.

### DETAILED DESCRIPTION

In this patent application, the following words are defined as follows. “Groups” are a number of users sharing the invention (aka “Video Scout”) evaluations and providing feedback privately within their group of professionals, coaching staff, etc for sharing and collaborating on athletes. Any role can create or join a group except Player/Participant. “Players” (or participants) is one of the 4 roles (Players/Participant, Coach/Instructor, Scout, Team Owner/Management) elected when registering. These users can only receive and see their own evaluations as published online by Video Scout. These users have the least amount of permissions within Video Scout. “Team Owners/Management” have the most control over permissions within Video Scout and can do almost everything that Video Scout Admin can with a few exceptions like deleting or altering video, events, users and their settings. They can control other user roles such as Coach/Instructor and Scout to allow or disallow them from using or even seeing Video Scout reports and/or feedback from users. They, in essence control the information and how and when it is shared and with whom. “Scouts” are user roles that are usually independent. They can see public events for the sport they are registered in. They can belong to groups but may also be interested in seeing other events and evaluations outside their groups (if they belong to one) Very few permissions over who sees what as they are just trying to see and gather information on as many athletes as they can see. “Coach/Instructor” is about the same level of permissions as a Team Owner/Management with the additional controls over an event, and videos and who sees players, public or private and tag players in videos so they may receive their evaluations. In the case of documenting players at camps or tryouts they may be private for that coach's school or institution. It is important for them to control the information and the participants because they are the ones who know the players and who is in attendance. They will, in turn, tag and distribute the evaluations and reports to the players. Naturally they may also belong to a group or own a group so that the coach and his staff may privately meet concerning players they may be interested in. Similar role as Team Owner/Management but with less permissions. Team Owner/Management is more for Professional sports teams and Coach/Instructor is more for Amateur, College, High School, Camps, Tryouts and for those users to control their own events where Video Scout documentation is taking place. “Group Page” is where the private sharing is happening with reports and feedback. There is a public page and a Group Page will appear on your account if you own or belong to one. “Admin” refers to Video Scout and it's directors, in general the disclosed website administrators or operators.

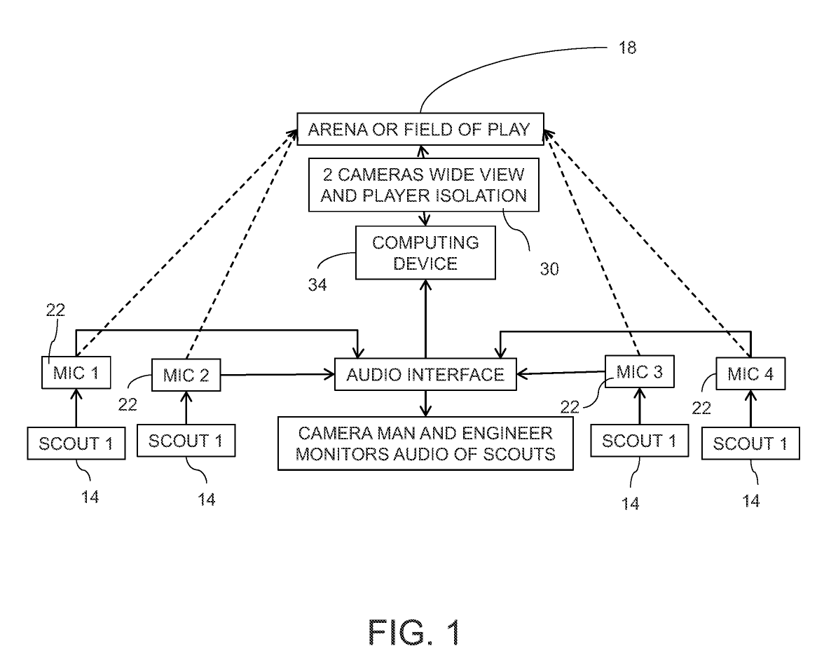

FIG. 1 is a schematic diagram showing one embodiment of the system 10. A plurality of scouts 14 are viewing the arena or field of play 18. The term “scout” as used in this patent application includes a sports scout, and a person evaluating a performance (either athletic, artistic, or the work of an individual such as a referee). The arena or field of play shall include, but are not limited to: sports fields, athletic fields, courts for playing sports, gymnasiums, tennis courts, basketball courts, and stages for artistic and/or athletic performances, ice rinks, and any field of play for a sporting event. The scouts 14 are positioned such that they can see the arena or field of play. The scouts 14 will each have their own microphone 22. The microphones will be in signal communication with an audio interface 26. Two cameras 30 will be aimed on the field of play and/or a particular player or performer. A cameraman may be operating the cameras. One camera will generally be focused on the play near a particular player being scouted. A second camera will be zoomed in and generally isolate the player being scouted. “Player” as used in this patent application includes a sports player, an artistic performer, a person in the course of his or her work (a referee or umpire for example). In one embodiment, the two cameras may be attached to a single camera stand that is configured to hold two cameras, with one camera generally seeing the field of play, and one camera focused in and generally isolating the player being scouted. Both cameras are in signal communication with a computing device 34. In addition, the audio interface 26 is also in signal communication with the computing device 34. Throughout this patent application, numerous references will be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium. For example, a server can include one or more computers operating as a web server, database server, or other type of computer server in a manner to fulfill described roles, responsibilities, or functions. Within the context of this document, the disclosed printers, assemblies, or space craft are also deemed to comprise computing devices having a processor and a non-transitory memory storing instructions executable by the processor that cause the device to control, manage, or otherwise manipulate the features of the assemblies. A cameraman and/or engineer 38 may be monitoring the audio being received from the microphones 22 of the scouts 14.

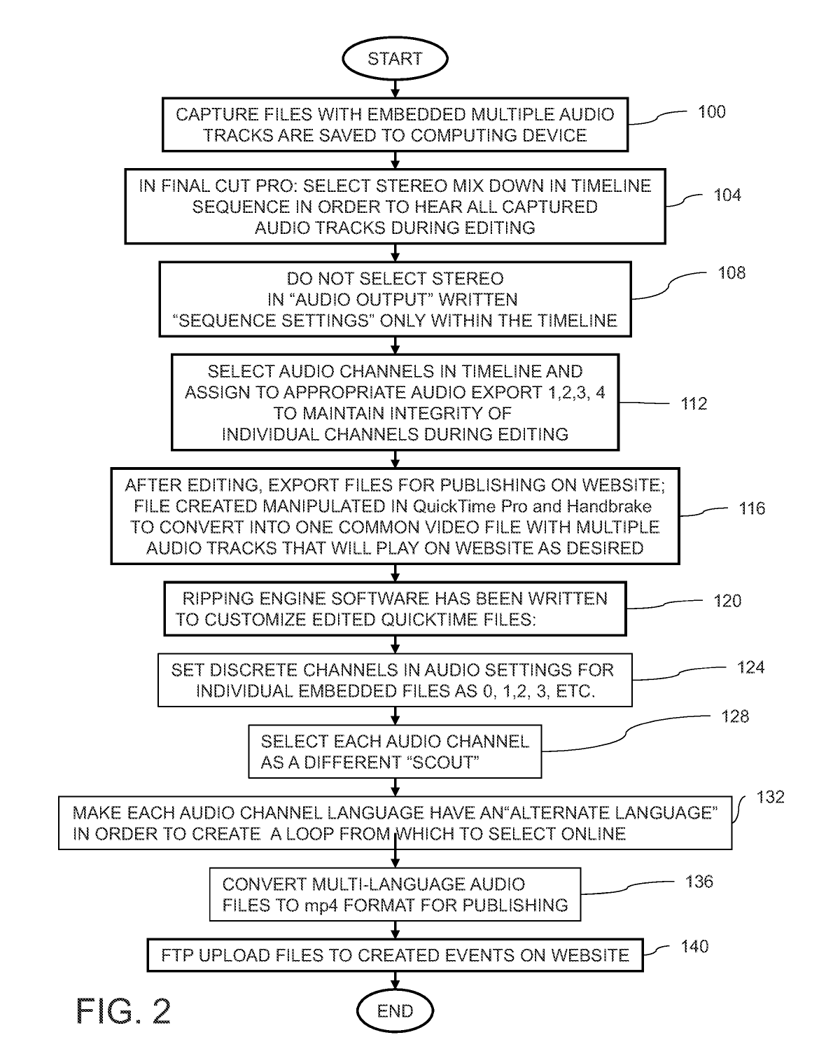

Once the audio and video is captured on the computing device 34, the audio and video files will go through post production. FIG. 2 shows one embodiment of the post production method. At act 100, the captured video files with the embedded multiple audio tracks are saved to the computing device. At act 104, using editing software, such as, but not limited to Final Cut Pro, stereo mix down in timeline sequence is selected in order to hear all captured audio tracks during editing. At act 108, stereo is not selected in “audio output” within “sequence settings” only within the timeline. At act 112, audio channels in timeline are selected and assigned to appropriate audio export, 1, 2, 3, 4 for example, to maintaining integrity of individual channels during editing. At act 116, after editing, files are exported for publishing on a website, such as, but not limited to videoscout.org. The created file is manipulated in QuickTime Pro and Handbrake to convert into one common video file with multiple audio tracks that will play on the website as desired. At act 120, running ripping engine software to customize edited QuickTime files, and does the following acts 124-136. At act 124, setting discrete channels in audio settings for individual embedded files as 0, 1, 2, 3, etc. At act 128, selecting each audio channel as a different “scout”. At act 132 making each audio channel language have an “alternate language” in order to create a loop from which to select online. At act 136 converting multi-language audio files to mp4 format for publishing. At act 140, FTP uploads files to created events on website.

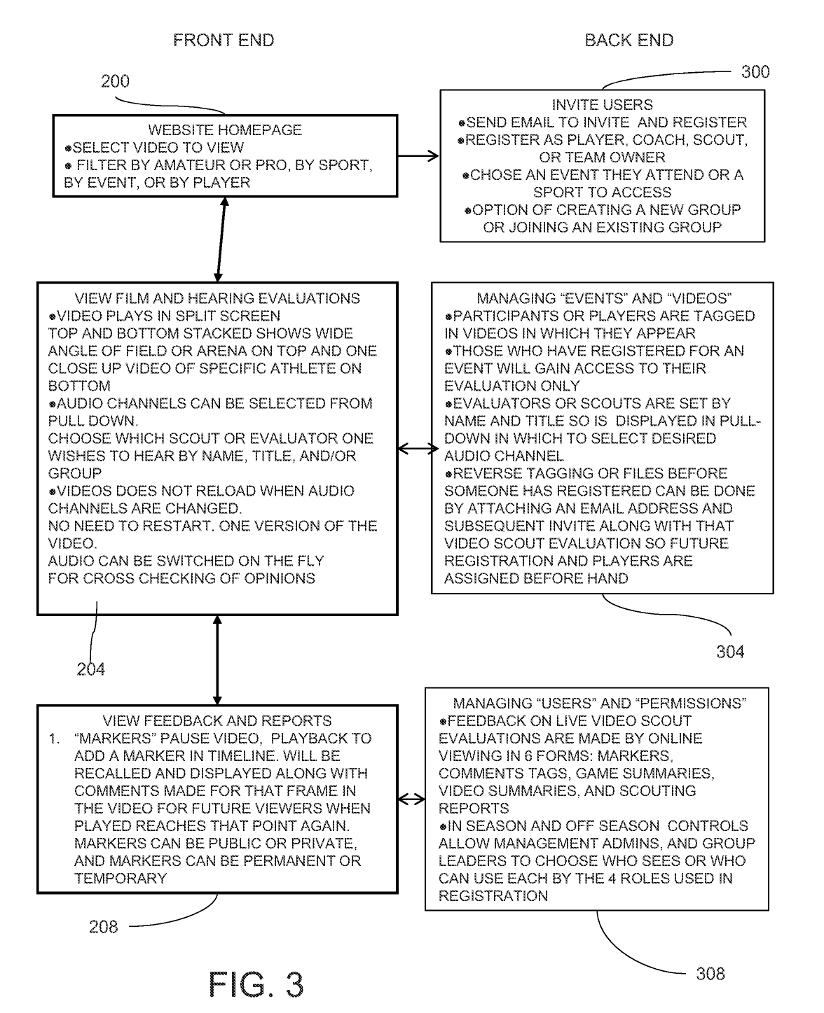

The disclosed system may be implemented in a computing system that includes a back-end component, e.g., as a data server, or that includes a middleware component, e.g., an application server, or that includes a front-end component, e.g., a client computing device having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks). FIG. 3 shows a block diagram illustrating a portion of the front end and back end of a video and audio evaluation website that allows users to access the information recorded at the arena or field of play, as well as other information. Block 200 shows the website homepage, where a user can select a video to view and listen to, and can filter by various filters, including, but not limited to: amateur or prof, sport, event, or player. Block 204 shows further user option on the website, including: view film and hearing evaluations; video plays in split screen top and bottom stacked so that the top screen shows a wide angle of field or arena (in one embodiment) and the bottom screen shows a close up video of a specific athlete, that is synched with the top screen; using pull down menus to select from multiple audio channels; choosing which scout or evaluator to hear by name, title, and/or group; user can change audio channel on the fly without requiring reloading of the video—this allows for cross-checking of opinions while watching video. Block 208 shows more options for the user, including the ability to view feedback and reports. Under the view feedback and reports option, the user can use “markers”. Markers can be added to the video by pausing the video, then playing back to add a marker in timeline. When the video is replayed, the markers be recalled and displayed along with comments made for that frame in the video for future viewers when the video reaches the place in the vide where the marker was “attached”. Markers can be public or private, and markers can be permanent or temporary. Block 300 is the first back end component of the website. The website operator can invite users. Inviting users may involve sending email to potential users to invite them and allow them to register at the website. Generally, when registering, the users can register as player, coach, scout, or team owner, and they can choose an event they attend or a sport to access. The registration process gives the user the option of creating a new group or joining an existing group. Block 304 describes the back end process of managing “events” and “videos”. Participants and/or players are tagged in videos in which they appear, the participants and/or players who have registered for an event will be given access only to their own evaluations. Evaluators and/or scouts are listed by name and title and are so displayed in pull-down menus, so that a user can select a particular evaluator and/or scout's audio feed. Reverse tagging of files before someone has registered can be done by attaching an email address and subsequent invite along with that video's scout evaluation so future registration and players are assigned beforehand. Block 308 describes managing “users’ and “permissions”. This management includes allowing feedback on live video scout evaluations in six formats: markers, comments tags, game summaries, video summaries, and scouting reports. In season and off season controls allow website operators, administrators, and group leaders to choose who sees or who can use each by the 4 roles used in registration (player, coach, scout, team owner).

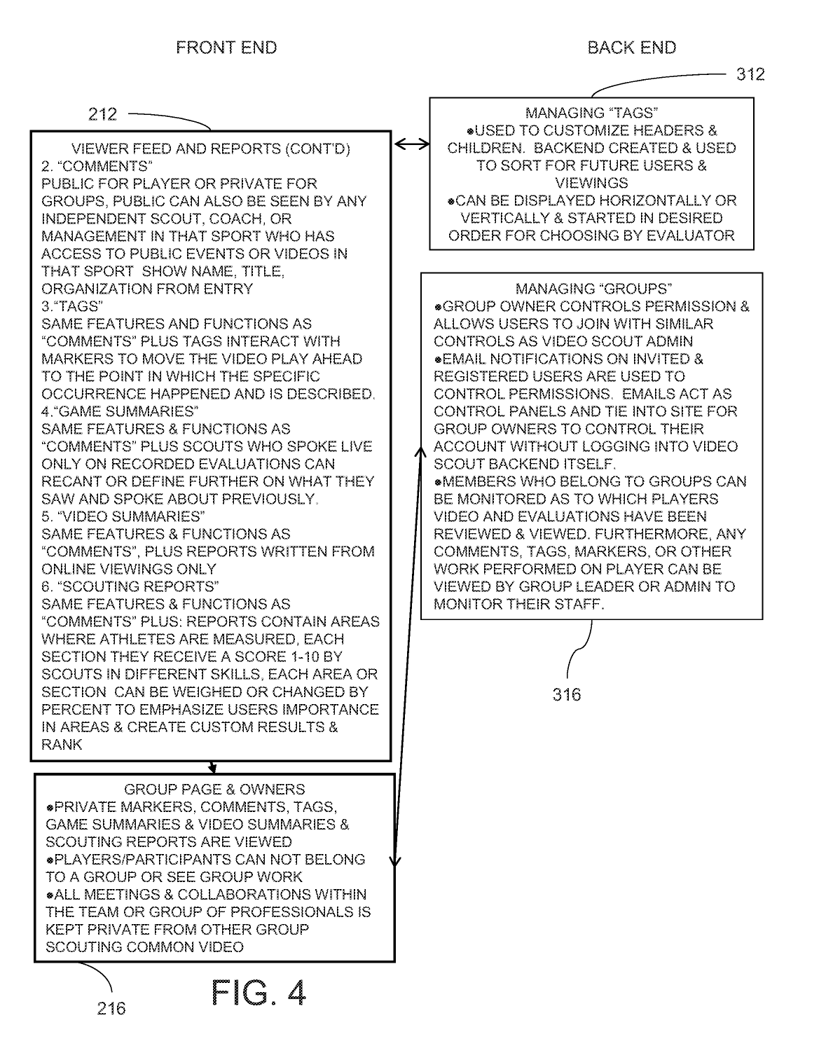

FIG. 4 is a continuation of the block diagram from FIG. 3. Block 212 is generally a continuation of block 208 from FIG. 3. Under the view feedback and reports option, the user can use “comments”. Comments may be public for players or private for groups, public comments can also be seen by any independent scout, coach, or management in the sport the player is association with and who has access to public events or videos in that sport. Comments will generally show the name, title, and organization of the author of comment. “Tags” may have the same features and functions as “comments”, in addition, tags interact with markers to move the video play ahead to the point in which the specific occurrence happened and is described. “Game summaries” may have the same features & functions as “comments”, plus allowing scouts who were recorded during the live evaluation the opportunity to recant, modify, or define further on what they saw and spoke about previously. “Video summaries” may have the same features & functions as “comments”, plus reports written from users who have viewed the videos online. “Scouting reports” may have the same features and functions as “comments”, and in addition contain areas where athletes are scored in according to various skills. For example, the athlete may be able to receive a score of 1-10 for each skill, with 10 being the highest. The scores may be entered by scouts. The scores in the various skills can be weighed differently or changed by percent to emphasize user's desired importance in various skills, positions, areas, and allow users to create custom results and rankings of players. Block 216 describes how Owners of teams can use “Group Pages”. Owners can view private markers, comments, tags, game summaries, video summaries, and scouting reports. In one embodiment, players and/or participants cannot belong to a group or see group work (such as private markers, comments, tags, game summaries, video summaries, and scouting reports). All meetings and collaborations within the team or group of professionals are kept private from other groups and owners who are reviewing the same scouting video. Block 312 describes how tags can be managed on the back end. Tags are used to customize headers, header children. Tags are created in the back end and may be used to sort for future users and viewings. Tags can be displayed horizontally or vertically, and started in desired order for choosing by evaluator. Block 316 describes how groups can be managed in the back end. Group owner controls permission and allows users to join with similar controls as website operators. Emails may be sent from website to invite and register users. The emails can act as control panels and tie into website for group owners to control the invited users account without having to log into the website backend itself. Members who belong to groups can be monitored as to which player's video and evaluations have been reviewed and viewed. In addition, any comments, tags, markers, or other work performed on player can be viewed by group leader or admin to monitor their staff. Any one can own or belong to a group EXCEPT the role of “Player/Participant” The Group Leader or Owner controls who sees what within their Group. Scouts and Coaches can belong to that Group and other coaching staff, recruiting coordinators, operations personnel and management. The Group Owner, for example, may want his scouts to see “Markers” within Video Scout evaluations but not scouting reports since they don't want their scouts sharing information or opinions on players. Or they want their coaches to see Comments and Tags but they don't want them to see Markers. Each feedback tool can be controlled independently according to the user roles within the group.

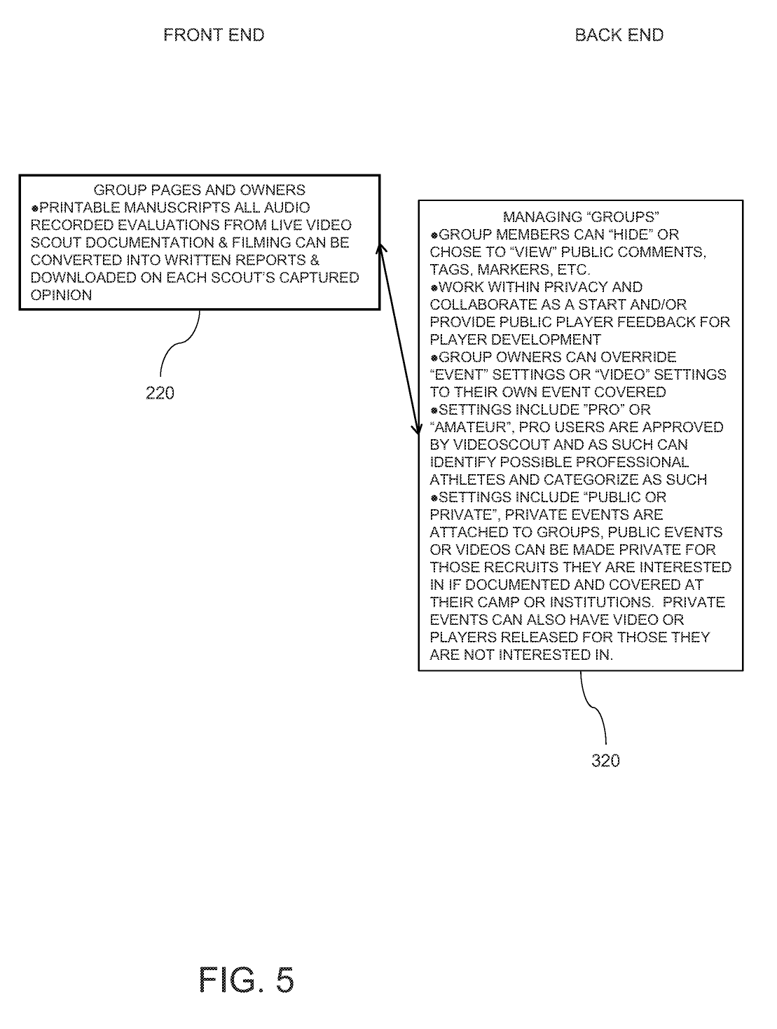

FIG. 5 continues the block diagram of FIGS. 3 and 4. Block 220 shows how owners can modify group pages. Owners can request audio to text conversions in order to obtain printable manuscripts of all spoken evaluations from the audio recordings of the scouts. Block 320 shows how groups may be managed on the back end. Group members can “hide” or chose to “view” public comments, tags, markers, etc. Group members can work together and collaborate privately, and/or provide public player feedback for player development. Group owners can override “event” settings or “video” settings to their own events. Settings include “pro” or “amateur”. Pro users are approved by the website operator and as such can identify possible professional athletes and categorize those athletes as potentials. Settings include “public or private”. Private events are attached to groups, public events or videos can be made private for those potential recruits Group owners are interested, if those potential recruits were “scouted” at a group owner's camp or institution. Private events can also have video or players released for those they are not interested in, and allowed to go public so other users can see those potential recruits.

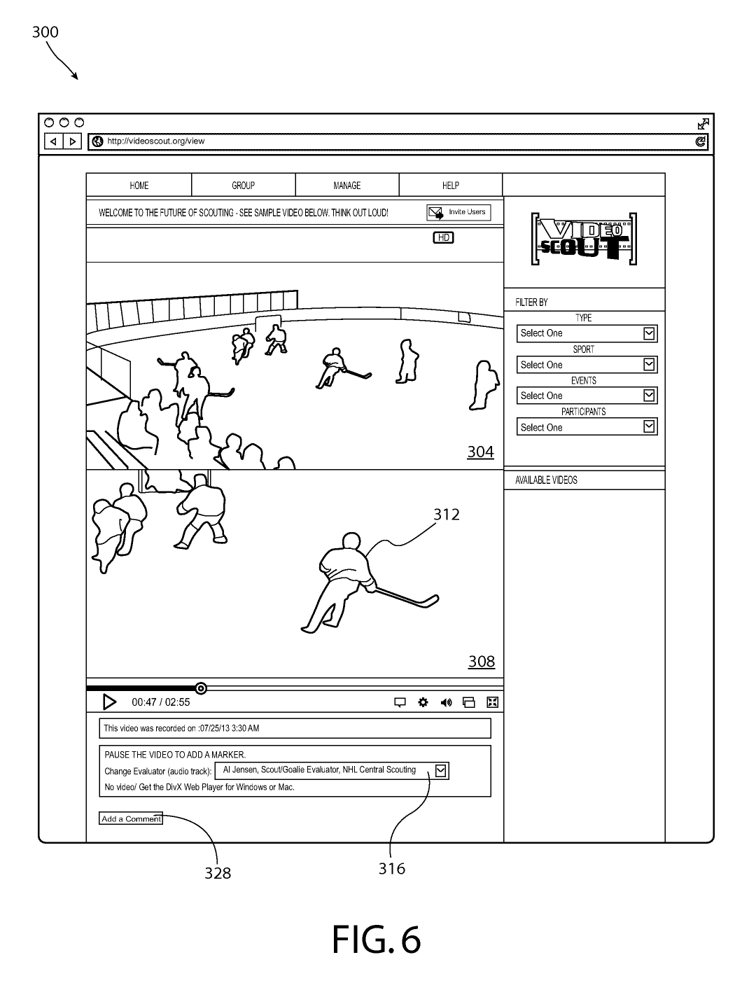

FIG. 6 is a screen shot 300 of one embodiment of a website embodying the disclosed system. The screen shot shows an upper video 304 and a lower video 308. Upper video is a shot of the action happening around a hockey player 312. Lower video 308 is a close up view of the subject hockey player 312, occurring at the same time as upper video 304. During the playing of the videos 304, 308, a particular scout audio is being played; the particular scout's identity is shown in pull down menu 316. A different audio can be played on the fly during the videos 304, 308 playback. Also note the Add a Comment button 328.

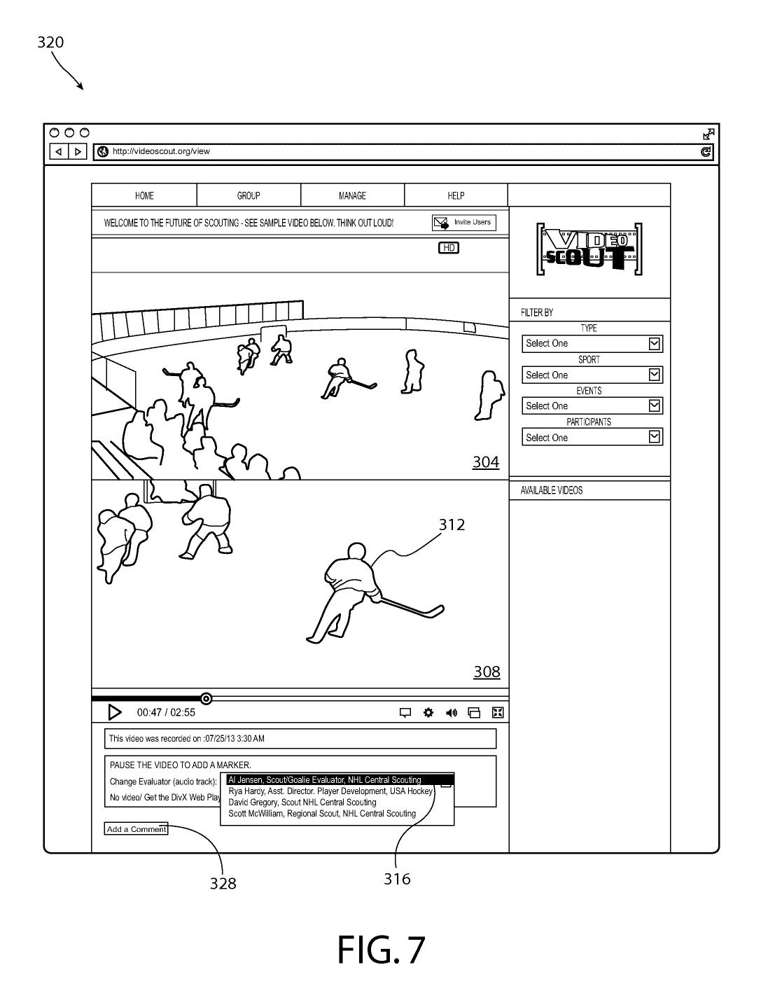

FIG. 7 is a screen shot 320 of the page from FIG. 6, however note the pull-down menu 316 has been clicked, and the four options of different scout's audio may be selected, all while the video is playing on the fly. In another embodiment, the video play may pause automatically when a user is selecting a different audio, and then the video plays from where the video was paused.

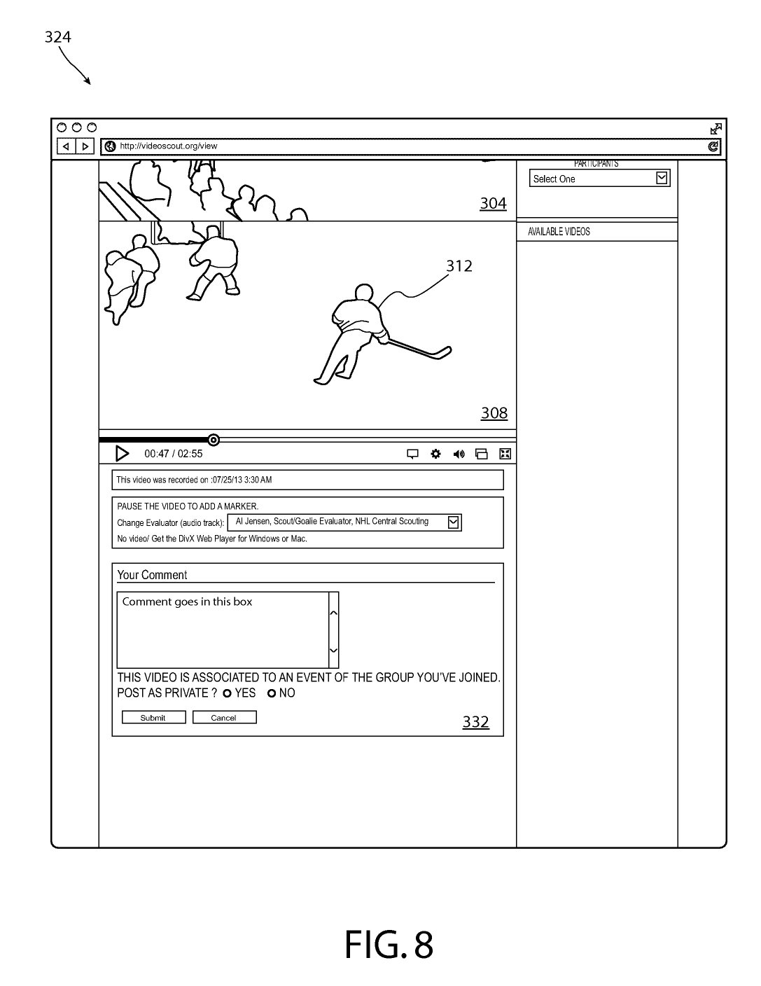

FIG. 8 is a screen shot 324 of the page from FIG. 6, however, in this view the add a comment button 328 has been clicked revealing a comment window 332 to allow a user to add a comment.

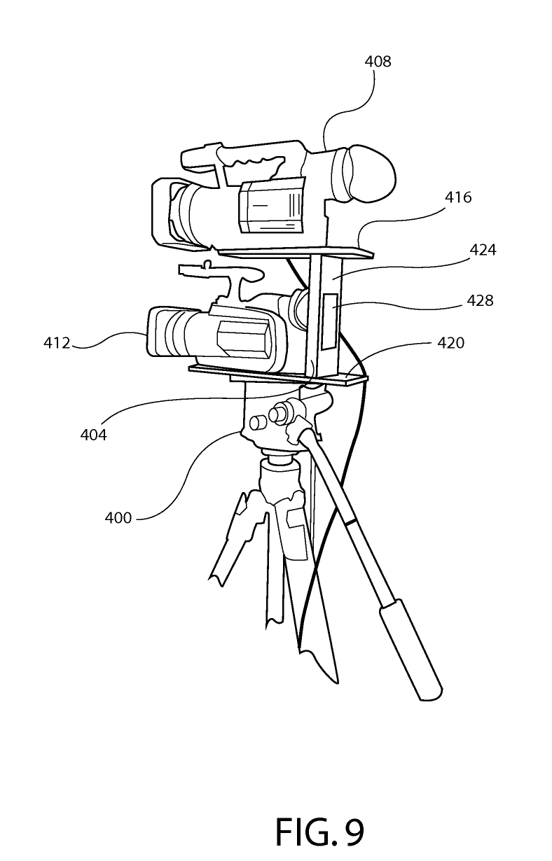

FIG. 9 is a perspective side view of one embodiment of a two camera stand 400. The two camera stand 400 comprises a modified bracket 404 that allows for an upper camera 408 and a lower camera 412 to be able to be trained on generally the same area of the arena or field of play. In one embodiment, the upper camera can be focused to see a wider view of the arena or field of play, and the lower camera may be zoomed in on one player of performer being scouted or evaluated. The bracket 404 has an upper base 416, and a lower base 420. A vertical member 424 is attached to both bases 416, 420. The vertical member may an attachment means 428, such as a Velcro patch. Thus, when a cameraman is keeping the lower camera on the player, and rotating and pivoting the lower camera, the upper camera moves in tandem with the lower camera, so that a wider view is always being filmed with the player in the wider view, and a more focused view on the individual player is being filmed simultaneously. In another embodiment, 428 may be a cut out to allow an operator to see through the viewer of the lower camera 412.

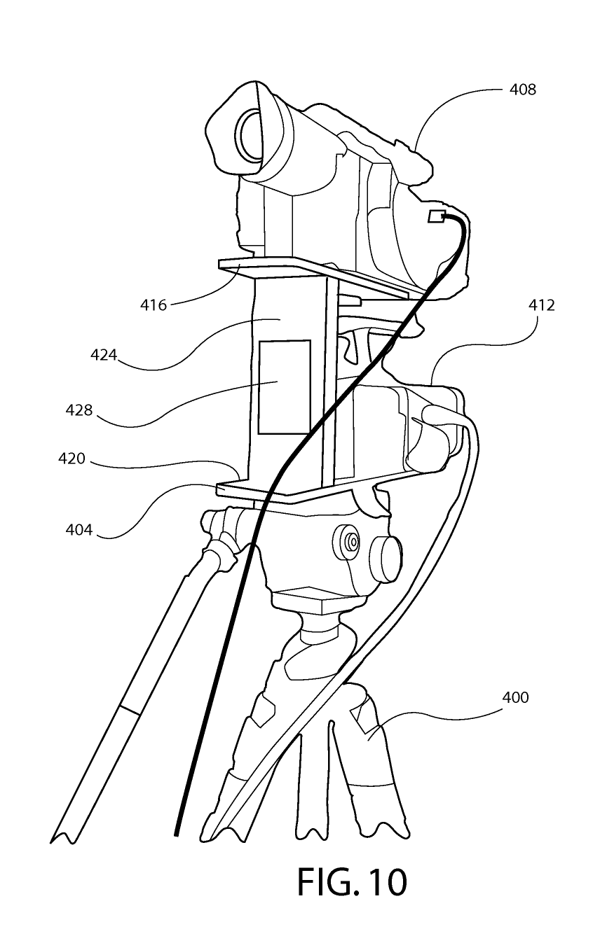

FIG. 10 is a rear perspective view of the two camera video stand 400 from FIG. 9.

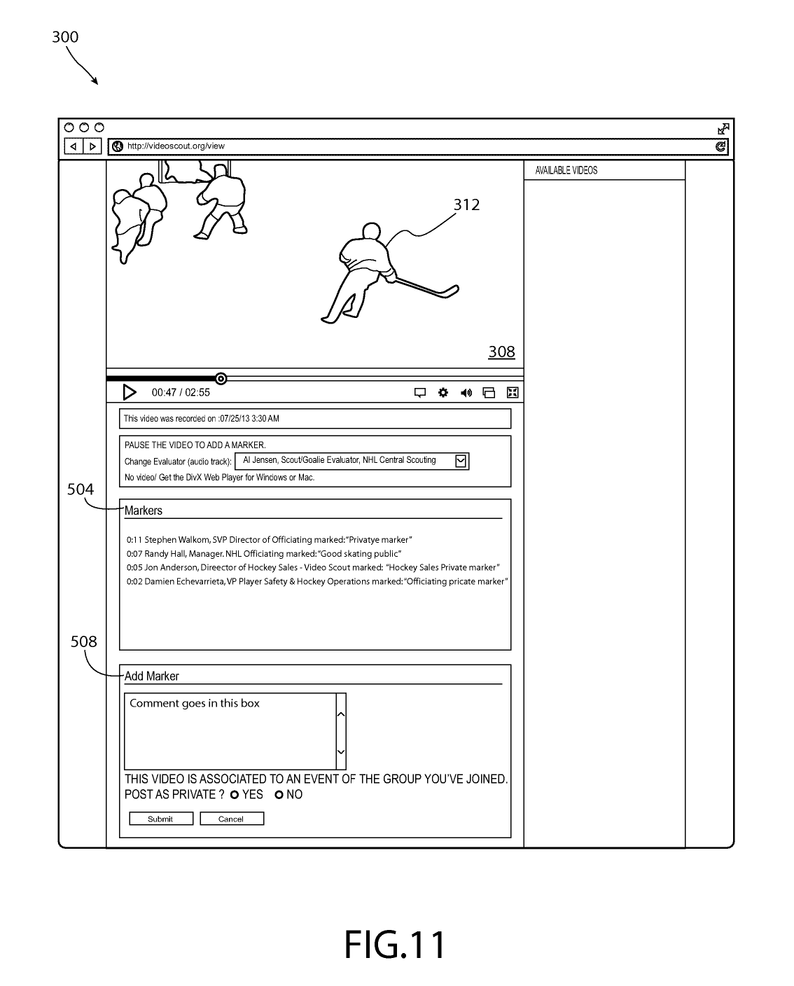

FIG. 11 is another screen shot 500 of one embodiment of a website embodying the disclosed system. In this screen shot, the user has paused the video. When the video is paused, an “add a marker button” appears. In this screen shot, the add a marker button has been pressed. Note the time codes on page that appear in the markers window 504 and refer to other markers already in the video. At the add marker window 508, the user can add his own marker and description of what he wants to note about the video and/or player 312. One can see that the marker in this figure will be added at the 27 second mark of the video.

The disclosed system may provide many options for users. The system may allow for downloadable and printable manuscript from the scout's audio tracks. The video may have interactive markers in timeline. Thus when an interactive marker is clicked on, the current video is moved to a point on the timeline associated with the marker. This may also be described as having the play head moves to time code point, associated with the marker, in the scrub bar. Emails may act as a control panel for group owners and administrators without having to log into the website and control from back end. The emails will allow interaction with the owners account. Markers may expand to also select situations or events such as goals, short handed shifts, power plays, saves, etc. Then, those events, associated with the markers, can be searched/sorted by player. The markers would be configured to tie into a players account so a user can see all goals by a player or all short handed shifts by a player, for example. Mark in and out points and create edits by user. Online edits or marked film show up as sub clips underneath main video. The previous two sentences generally means that this is a way to make online edits from a much larger video A video may be 20 minutes long but by identifying the start or “in” point and the end or “out” point a user can define and edit a smaller, shorter video that contains exactly what is tagged. So while Johnny Jones, for example, has a 20 minute Video Scout evaluation that appears, his sub clip where he scored a goal (for example), is a shift between 3:45 and 4:30. This appears as another video and is categorized so that a user can select all of Johnny Jones' goals and all those clips will appear and can be played in a loop back to back This can be true for all ground balls a shortstop makes or all diving catches in the outfield that are made, etc. Audio critiques may be captured online from users who are viewing the videos and speaking into a microphone, and added as additional channels from users. The audio would be captured in sync with video as user is watching and recording his or her voice. The additional audio critiques would show up in pull downs as additional evaluations. The disclosed system may be used remotely, that is, scouts may be located away from the field of play or arena, but may be watching the event online, and recording their audio tracks while watching the event online. The event may be live, or prerecorded. The disclosed system may use wireless systems for placing scouts at different positions, and the position of scouts may be displayed on a map of the arena or field of play. The map may be available on the website for users. Scouting reports can be weighed differently dependent on needs of the person/team looking for a new player.

This invention has many advantages. The disclosed invention, which may also be called “Video Scout”, allows for the documenting professional prospects, college prospects, camps and even little league town tryouts by capturing several opinions at the same time and can provide instantaneous cross checking of players. Coaches and scouts can get more information down on a player than a written evaluation. Scouts do not like writing evaluations and they can mean very little to another coach, parent or player receiving them. The invention allows for multiple opinion capturing, in real time and in sync with video provides a frame of reference to when and why an evaluator arrived at an opinion. First impressions may be considered “everything” in scouting and Video Scout gets inside a scout or coaches head by getting them to “think out loud.” The library of documented players can be shared and later reviewed. Team owners and Head Coaches can finally see what their scouts see at the same time while formulating opinions and evaluating prospects with a frame of reference while watching video. Integrity is provided in cross checking evaluations since scouts are not collaborating or influencing each other. Communication may be one way and may be isolated from other scouts. Therefore, if all scouts say the same thing, it can be considered true. Video Scout takes videotaping of prospects to an entirely new level. In the past, very few athletes have been recruited from just film alone. Decision makers will always want to see a prospect play live. Video Scout brings the game to those not in attendance as if they were there: seeing and hearing real world evaluations and opinions as they are made. The disclosed invention may be used for applications under medical, military, and player safety in sports as well as performance, officiating, scouting.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A method of scouting players in a sporting event, the method comprising:
configuring a computer to operate as a scouting information management engine;
receiving, by the scouting information management engine, scouting data;
creating a multimedia scouting report using the scouting data received by the scouting information management engine;
configuring an output device to provide the multimedia scouting report to a user.

2. The method of claim 1, further comprising:
receiving, by the scouting information management system, a first amount of video data from a first camera, wherein the first camera has a wide focus on a field of play;
receiving, by the scouting information management system, a second amount of video data from a second camera that is filming simultaneously with the first camera, wherein the second camera has a narrow focus on one player.

3. The method of claim 2, further comprising:
receiving, by the scouting information management system, a first audio recording from a first scout watching and evaluating one player on a field of play, said first audio recording being recorded simultaneously with the filming of the first amount of video data and second amount video data.

4. The method of claim 2, further comprising:
receiving, by the scouting information management system, a plurality of audio recordings from a plurality of scouts, each of the scouts watching and evaluating the same one player on a field of play, each of the plurality of audio recordings being recorded simultaneously with the filming of the first amount of video data and second amount video data.

5. The method of claim 2, further comprising:
creating a multimedia scouting report, where one page of the report provides a first video window and a second video window, where the first video window shows the first amount of video data from the first camera, and where the second video window shows the second amount of video data from the second camera, both video windows play simultaneously with each other.

6. The method of claim 4, further comprising:
creating a multimedia scouting report, where one page of the report provides a first video window and a second video window, where the first video window shows the first amount of video data from the first camera, and where the second video window shows the second amount of video data from the second camera, both video windows play simultaneously with each other, and where the one page of the report also has a pull-down menu to allow a user to select any of the plurality of scout's audio recording to play on the fly during the playing of videos in the first and second video windows, without the need to restart the videos.

7. The method of claim 4, further comprising:
configuring the video data and audio recordings for the multimedia scouting report, the configuring comprising:
saving captured video files with the embedded multiple audio tracks to a computing device;
selecting stereo mix down in timeline sequence in order to hear all captured audio tracks during editing;
selecting audio channels in timeline and assigning to appropriate audio export;
editing audio and video files;
exporting audio and video files for publishing on a website;
manipulating audio and video files into one common video file with multiple audio tracks that will play on website;
running ripping engine software to customize edited QuickTime files;
setting discrete channels in audio settings for individual embedded files;
selecting each audio channel as a different scout;
making each audio channel language have an alternate language in order to create a loop from which to select online;
converting multi-language audio files to mp4 format for publishing; and
uploading files to created events on website.

8. A player scouting system comprising:
a scouting information management engine configured to:
receive scouting data;
create a multimedia scouting report using the scouting data;
configure an output device to provide the multimedia scouting report to a user.

9. The player scouting system of claim 8, further comprising:
a first camera in signal communication with the scouting information management engine, the first camera focused on a portion of the field of play;
a second camera in signal communication with the scouting information management engine, the second camera focused on one player, the second camera filming simultaneously with the first camera.

10. The player scouting system of claim 9 further comprising:
a first scout recording into a microphone in signal communication with the scouting information management engine, the recording simultaneous with the filming of the first and second camera.

11. The player scouting system of claim 9 further comprising:
a plurality of scouts each recording into a microphone, each microphone in signal communication with the scouting information management engine, the recordings simultaneous with the filming of the first and second camera.

12. The player scouting system of claim 9, where the multimedia scouting report comprises:
a first page with a first video window and a second video window, where the first video window shows video from the from the first camera, and where the second video window shows video from the second camera, both video windows play simultaneously with each other.

13. The player scouting system of claim 11, where the multimedia scouting report comprises:
a first page with a first video window and a second video window, where the first video window shows video from the from the first camera, and where the second video window shows video from the second camera, both video windows play simultaneously with each other;
a pull-down menu on the first page, where the pull-down menu allows a user to select any of the plurality of scout's audio recordings to play on the fly during the playing of videos in the first and second video windows, without the need to restart the videos.

14. The player scouting system of claim 9, further comprising:
a two camera stand, the two camera stand comprising:
a bracket attached to the stand, the bracket comprising:
an upper base;
a vertical member attached to the upper base;
a lower base attached to the vertical member and located below the upper base;
the first camera attached to the upper base;
the second camera attached to the lower base.

15. The player scouting system of claim 9, further comprising:
a cut out located in the vertical member configured to allow an operator to see through the view finder of the second camera.

16. The player scouting system of claim 9, further comprising:
a Velcro patch located on the vertical member.
